(19) United States
(12) Patent Application Publication
(10) Pub. No.: US 2012/0198531 A1
(43) Pub. Date: Aug. 2, 2012

(54) MULTI-DEVICE SESSION PAIRING USING A VISUAL TAG

(75) Inventors: Jeffrey Ort, Seattle, WA (US); Joseph Bertolami, Seattle, WA (US); Shyam Habarakada, Seattle, WA (US)

(73) Assignee: Microsoft Corporation, Redmond, WA (US)

(21) Appl. No.: 13/017,172

(22) Filed: Jan. 31, 2011

(51) Int. Cl. G06F 21/20; G06F 15/16

(52) U.S. Cl. 726/7; 709/227

(57) ABSTRACT

One or more techniques and/or systems are disclosed for joining two or more devices in a multi-device communication session. A request is received from a first device, such as at a session hosting service on a remote server, to initiate a multi-device communication session, such on the session hosting service. A visual tag is sent to the first device, such as from the session service, where the visual tag comprises device-session pairing information, such as session service identification and session authorization. A multi-device communication session joining request is received from a second device, where the request from the second device comprises the device-session pairing information retrieved from the visual tag displayed by the first device, and captured by the second device.

### BACKGROUND

Computing devices often comprise portable devices, such as smartphones, laptop computers, tablet devices, etc., which can respectively comprise network connection capabilities (e.g., wifi, Bluetooth, mobile phone connections, plugged connections, etc.). Some short-range wireless technologies and wired connections may allow communications between devices located within close proximity of each other; however, security threats may be present in a public connection environment. That is, an attacking device can be within transmission range of the computing device to intercept and/or inject communications. Nonetheless, security features typically are employed to promote computing device association and/or communication with merely trusted and/or authorized devices.

Typically, when two or more devices wish to communicate in a private session a pairing or joining process is performed so that a portable device is “trusted” before it is associated with a computing device. For example, when a computing device initiates a communication session with another device, a user of the other device is typically prompted to interact with one or both of the devices to authorize the joining of the computing device to the session. Once joined, the two or more devices can communicate with each other in a private session, such as to collaborate, chat, or play cooperative games, for example.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The pairing or joining of two (or more) devices is a common action for a variety of purposes. Current solutions to device pairing implement a secure method that has no previous connection knowledge between the two devices. In current systems, the pairing is performed by utilizing display and input capabilities of the devices involved, for example, depending on human input (e.g. typing in passcodes) for completing the action of pairing. Typically, when two or more devices wish to join in a private shared session, each device displays a key, such as a numerical value, and the users are prompted to enter “yes” on one or both of the devices if the two displayed key values match.

This is often performed to verify that the users are in control of both devices so that the portable device is trusted for the session. Such a user-aided authentication process is generally referred to as “manual pairing” as it requires an affirmative manual action by a user. Currently, for the manual pairing process, if the users confirm that trusted devices are connected, the devices can store security information (e.g., encrypted keys) for use in subsequent communications so that future association between the devices can be performed automatically by the devices without user action, for example.

Accordingly, one or more techniques and/or systems are disclosed where joining two or more devices into a shared multi-device session is simplified, such that user interaction (e.g., inputting of tokens) is mitigated. Visual tags, such as barcodes (e.g., 1D, 2D) or high color contrast barcodes (HCCB), for example, can comprise a plurality of information, which may be used to join a plurality of devices in a shared communication session. For example, the visual tag can comprise information that allows a device to identify a session service and authenticate to a session. In this example, the visual tag can be captured by a device, the pairing information retrieved from the tag by decoding, and then used to pair with a session (e.g., initiated by a host device).

In one embodiment for joining two or more devices in a multi-device communication session, a multi-device communication session initiation request is received from a first device, such as at a session hosting service. Further, in this embodiment, a visual tag is sent to the first device, where the visual tag comprises device-session pairing information. Additionally, a multi-device communication session joining request is received (e.g., by the session service) from a second device. Here, the multi-device communication session joining request can be initiated by the second device using the device-session pairing information retrieved from the visual tag that was displayed by the first device (e.g., and captured by the second device).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for joining two or more devices in a multi-device communication session.

FIG. 2 is a flow diagram illustrating one embodiment where one or more portions of one or more techniques described herein may be implemented.

FIG. 3 is a flow diagram illustrating an example embodiment where one or more portions of one or more techniques described herein may be implemented.

FIG. 4 is diagram illustrating an example embodiment for pairing two or more devices in a multi-device communication session.

FIG. 5 is a component diagram of an exemplary system for joining two or more devices in a multi-device communication session.

FIG. 6 is a component diagram illustrating an example embodiment of one or more systems described herein.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for pairing or joining two or more devices to a shared multi-device session, for example, where information can be shared, users can communicate, and/or join in multi-user application sessions. For example, a session service may host a multi-device session on a network and the devices can connect to the session by connecting with the session service on the network, such as using the Internet or an intranet, for example. Devices may connect to the session, for example, without looking up session connection information and/or requiring a user to manually enter information into a device for connection.

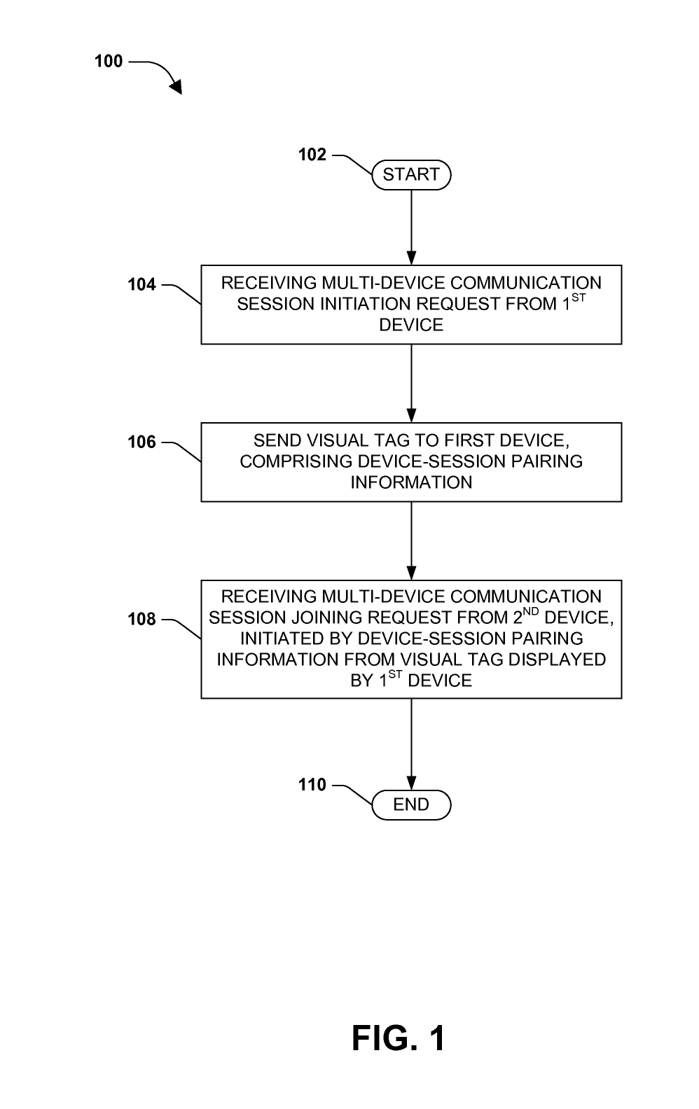

FIG. 1 is a flow diagram of an exemplary method 100 for joining two or more devices in a multi-device communication session. The exemplary method 100 begins at 102 and involves receiving a multi-device communication session initiation request from a first device, at 104. In one embodiment, a server that is remote from the first device, and may be hosting the multi-device communication session, can receive the multi-device communication session initiation request from the first device. For example, a user of the first device can start a multi-device session, such as where other users can connect and communicate, by contacting the session service on the remote server and initiating the multi-device session (e.g., by logging in and activating the application that begins a new or existing session).

At 106, a visual tag is sent to the first device, where the visual tag comprises device-session pairing information. For example, a bar code (e.g., or some other 1-dimensional code), quick response (QR) code (e.g., or some other matrix (2-D) barcode), a high capacity color barcode (HCCB), or some other readable image-based code may be generated for the initiated session and sent to the first device, which requested the session initiation. In one embodiment, the generated tag can comprise information that may be used by a device wishing to join the session, to connect with the session service.

For example, bar codes, QR codes, HCCBs, etc. can comprise encoded information, such as text, a uniform resource identifier (URI), personal contact information, or other some other data. In one embodiment, the tag can comprise a URI for the remote server that comprises the session hosting service, along with security information that may allow a device to join the session initiated by the first device.

At 108, in the exemplary method 100, a multi-device communication session joining request is received from a second device. Here, the multi-device communication session joining request is initiated by the second device using the device-session pairing information that is comprised in the visual tag displayed by the first device. For example, the tag can be sent from the session service comprised on the server to the first device that had initiated the session. In this example, the tag can comprise an image (e.g., of a type of code comprising session connecting information) that may be displayed on a screen connected to the device (e.g., a smartphone screen, laptop display, desktop display, etc.).

In one embodiment, the second device can capture the image of the tag displayed by the first device. For example, the second device may comprise (e.g., or be connected to) an image capture device or component, such as a camera. The image capture device can capture the image of the tag displayed by the first device, such as by taking a picture or video of the display. In one embodiment, the second device may comprise or utilize tag reading software, such as a barcode reader (e.g., QR code reader), for example, that can read the tag and decipher the information comprised in the tag. In this way, for example, the second device can retrieve the device-session pairing information from the tag, and use the information (e.g., URI and security information) to connect with the remote session server and join the session initiated by the first device, such as by sending a session joining request to the remote session server.

Having received the multi-device communication session joining request from the second device, the exemplary method 100 ends at 110.

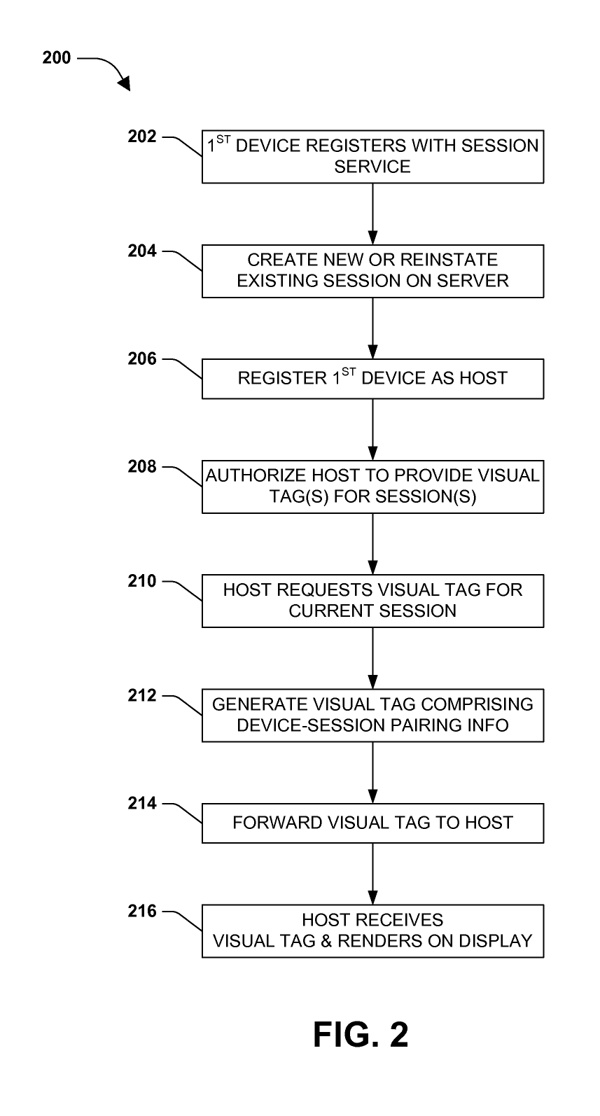

FIG. 2 is a flow diagram illustrating one embodiment 200 where one or more portions of one or more techniques described herein may be implemented. At 202, a first device can register with a session service, such as hosted on a remote server. As an example, the first device may utilize a uniform resource identifier (URI), such as a uniform resource locator (URL), to navigate to a session service site on the Internet. In this example, the session service can utilize a log-in page that the first device uses to register with the session service.

At 204, a new multi-device communication session can be created, or an existing multi-device communication session may be reinstated on the remote server hosting the session service. In one embodiment, the first device may request registration in a new multi-device communication session or in an existing multi-device communication session (e.g., a session previously created, which is to be reinstated), which can comprise receiving the multi-device communication session initiation request from the first device. For example, a first user may be using a laptop (e.g., first device) to play an online game and they may wish to have other second users join the online game, such as in a private room, to play the game together. In this example, the first user can set up the multi-device communication session by creating a new session with the session service.

At 206, the first device can be registered as the host for the session. For example, the multi-device communication session can comprise an environment with multiple devices and the session service hosted on the remote server. In this example, in the environment comprising the multiple devices, one of the devices typically take a role of session host, or session owner. Further, in this example, other devices that may be interested in joining the session may take a role of clients. A host/owner may be able to configure attributes and/or direct the environment (e.g., start and/or end (time) of the session, number of participants, etc.) of the session.

At 208, the session service can authorize the host to provide a visual tag for the session. In one embodiment, for example, the user hosting the session may register the session ahead of time in preparation for activating the session at a later time. In this embodiment, the user/host can be authorized to provide the visual tag for the session ahead of time, for example, and the user/host can then later activate the creation of the visual tag, such as by selecting an activation event (e.g., on a webpage for the session service). In another embodiment, the visual tag, comprising the device-session pairing information, can be generated in response to the receipt of the request from the first device, such as at the session service.

At 210, the host can request the visual tag for the current session, and the visual tag can be generated, at 212, comprising the device session pairing information. In one embodiment, the visual tag can be encoded with session related pairing information that may allow a second device to join the session initiated by the first device on the session server. For example, device session pairing information can comprise session information, which may provide an identification for the session (e.g., URI) such that the second device may link to the session server hosting the session service.

Further, for example, the device session pairing information can comprise session security information, such as one or more session authorization tokens, which may allow the second device to be authorized to pair with the session on the session server. Additionally, for example, the device session pairing information can comprise session lease expiry attributes, such as a session duration, end time, and/or a number of allowed devices, which can provide one or more desired limiting factors for the session. It is anticipated that other attributes that contribute to the multi-device communication session may also be encoded in the visual tag, such as desired form and function attributes that may limit a type of device joining the session, pre-authorized devices, and/or devices comprised in a desired geographic or network area, for example.

At 214 in the example embodiment 200, the visual tag is forwarded to the host device (e.g., first device) and, at 216, the host receives the visual tag and renders it on the display associated with the host device. In one embodiment, the session service can forward the visual tag to the first device in response to the request for the session from the first device. Further, for example, the first device (e.g., the host of the session) may receive the visual tag, such as in a browser (e.g., on a webpage for the session service) on the first device, in an email, in a text, or some other image receiving technique, and the visual tag can be displayed by the first device (e.g., on a smartphone screen, a display of a laptop or PC, or some other display associated with the first device). Additionally, in one embodiment, the host device may cache (e.g., store in memory) the visual tag for later use. For example, the caching can implement HTTP content caching comprising content expiration protocols, where the session service can retain control of when the visual tag expires (e.g., and may inform the host to refresh the cache on subsequent requests).

In one embodiment, the visual tag can be displayed on the first device, such as an image (e.g., comprising raster data, and/or vector data), so that the visual tag may be viewable from a second device. For example, the display of the first device comprising the image of the visual tag can be in a line of sight view from the second device, such that the second device may be able to capture the image of the visual tag. In another embodiment, the visual tag may be forwarded (e.g., emailed, texted, sent over a network connection) to remote display that can be viewed by the second device, which is also remote from the first device. In this embodiment, the second device can have a line-or-site view of the remote display, such as to capture the image of the visual tag from the remote display.

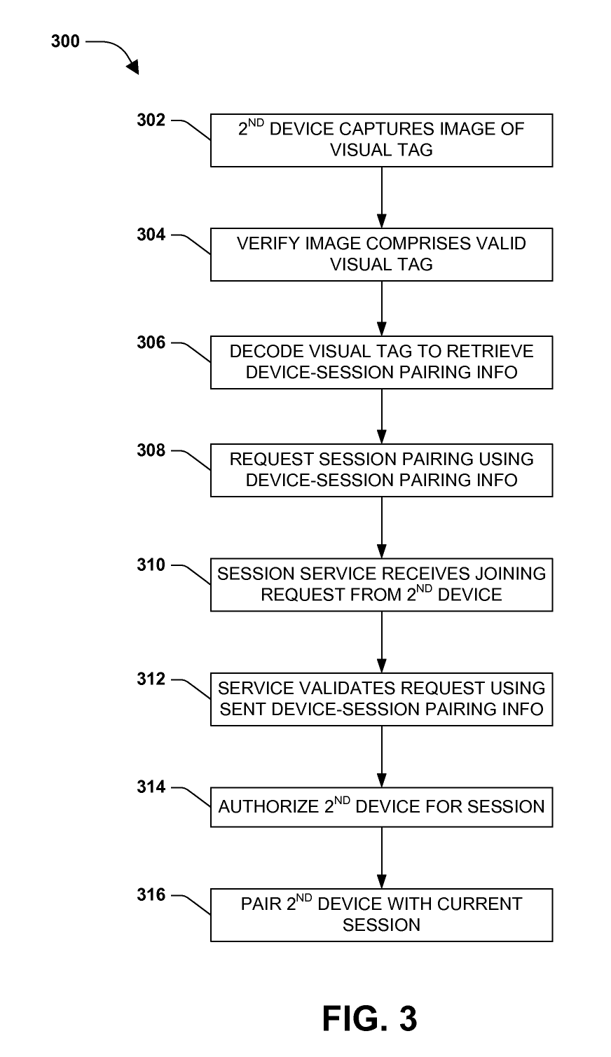

FIG. 3 is a flow diagram illustrating an example embodiment 300 where one or more portions of one or more techniques described herein may be implemented. At 302, the second device captures the visual tag that is displayed by the first device (e.g., or by a remote display). As an example, smartphones, laptops, digital cameras, and other portable devices (e.g., tablets) can comprise image capture components, such as still and/or video capture components. These image capture components can be directed toward the image of the visual tag, for example, and an image of the visual tag can be captured by the second device.

At 304, in one embodiment, the image can be examined to determine whether it comprises a valid visual tag. For example, programming resident on the second device may be configured to identify and/or decode visual tags. Sometimes, when an image is captured by an image capture component the image quality may not be sufficient to extract or read the visual tag (e.g., out of focus, too dark, image resolution poor, part missing, etc.). In this embodiment, the image can be examined to identify a valid visual tag, such as one that comprises information needed to connect with the multi-device communication session.

At 306, the captured visual tag can be decoded on the second device to identify the device-session pairing information. For example, software on the second device (e.g., client) can decode the visual tag and extract a textual representation (or other representation) of session-pairing data included in the tag. In one embodiment, the software used to verify the validity of the visual tag, and/or decode the visual tag, may be proprietary to a type of visual tag used. For example, a 2D barcode reader may be used for QR codes, a specific HCCB reader may be used for a particular type of HCCB code, and a barcode reader may be used for a 1D barcode. As described above, the visual tag comprises the information that can be used to join the session on the session server, which is extracted from the tag during the decoding.

At 308, a request to join the session, and pair the second device with the first device in the session, is sent using the device-session pairing information. In one embodiment, the second device can send the device-session pairing information (e.g., retrieved from the decoding) to the session server hosting the session, in response to capturing the visual tag displayed by the first device. For example, the second device may use a network connection (e.g., over the Internet or an intranet) to send the request to the remote session server. In this example, connection to the network can comprise different techniques for a plurality of devices, such as a smartphone using a 4G mobile phone link, and a laptop using a wifi link to access the network.

At 310, the session service receives the request to join the multi-device communication session initiated by the first device (e.g., host), such as on the remote server hosting the session service. At 312, the device-session pairing information received from the second device can be verified, such as by the session service. In one embodiment, the verifying can comprise determining whether the device-session pairing information is valid, such as for a current and/or valid pairing session hosted by the session service.

Further, in one embodiment, the verifying can comprise determining whether the device-session pairing information comprises a desired time interval for the multi-device communication session, for example, where the requested session is still open for joining based on a time limit (e.g., time to join, time duration of session, time from generation of visual tag, etc.). Additionally, the verifying can comprise determining whether a desired number of devices have already joined the multi-device communication session. For example, the host may have configured the session to merely comprise a limited number of devices paired to the session. If the number has been met, the request may be denied, otherwise the request may be granted. The verifying can also comprise determining whether the device-session pairing information comprises valid security information, such as a valid authorization token.

At 314, the second device (e.g., client) can be authorized to join the multi-device communication session initiated by the first device (e.g., host), if the device-session pairing information is verified appropriately. At 316, the second device can then be paired with the current session, such that the first and second devices may communicate in the session, and/or interact with each other in the session environment (e.g., gaming).

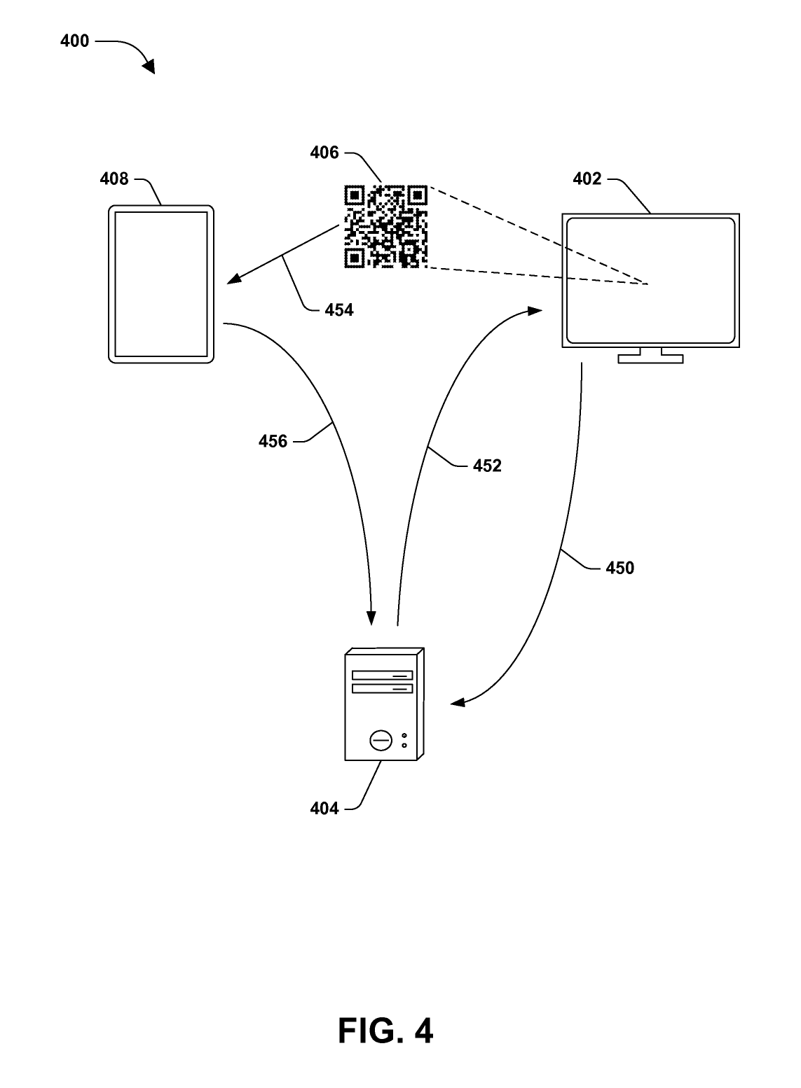

FIG. 4 is diagram illustrating an example embodiment 400 for pairing two or more devices in a multi-device communication session. A first device 402, which may also be the session host, communicates 450 with the session service comprised on a remote server 404. The communication 450 can comprise navigating to a website representing the session service, registering the first device 402 with the service, requesting a new session or reinstatement of an existing session, and/or requesting creation of a visual tag for the session. In response to the communication 450 from the first device 402, the session service on the remote server 404 may forward 452 a visual tag 406 to the first device 402.

The first device 402 can display the visual tag 406, which can comprise the device-session pairing information, such as a URI for the session service, authorization token, and/or expiry data for the session, for example. A second device 408 (e.g., client device), which may have a line-of-site view of the display of the first device 402 can capture 454 the image of the visual tag 406. For example, the second device 408 can comprise a camera that captures 454 the image of the visual tag 406 displayed on the display of the first device 402. The second device 408 decodes the visual tag 406, retrieving the device-session pairing information, and sends a request 456 to the session service on the remote server 404 to join the session, where the request 456 comprises the device-session pairing information. The session service validates the request and joins the second device to the session initiated by the first device.

For example, a first user and second user may be in a coffee shop and wish to have a shared, private session, such as for collaborating on some documents. In this example, the first user can initiate the session with their laptop, which thus serves as the first device, by navigating to the session service website, registering (or logging in), and requesting a new session. The session service can create a new visual tag for the session and send it back to the first user's laptop where it is displayed thereon. The first user shows it to the second user, and the second user takes a picture of the visual tag with their built-in camera on their laptop, which thus serves as the second device, decodes the visual tag, and sends a request to the session service to join the session. The session service receives and authorizes the request, then joins the second device with the first device, for example, thereby allowing the first and second users to collaborate.

A system may be devised that can join two or more devices (e.g., smartphones, laptops, PCs, tablets, etc.) to a shared multi-device session, for example, where the devices can communicate or collaborate in a private computing environment. For example, a session hosting service may reside on a remote server and host a multi-device session on a network, where the devices connect to the session by connecting with the session service on the network (e.g., over the Internet). Devices may connect to the session, for example, without looking up session connection information and entering the information into the device for connection, but merely by capturing an image of a visual tag comprising information for joining the session.

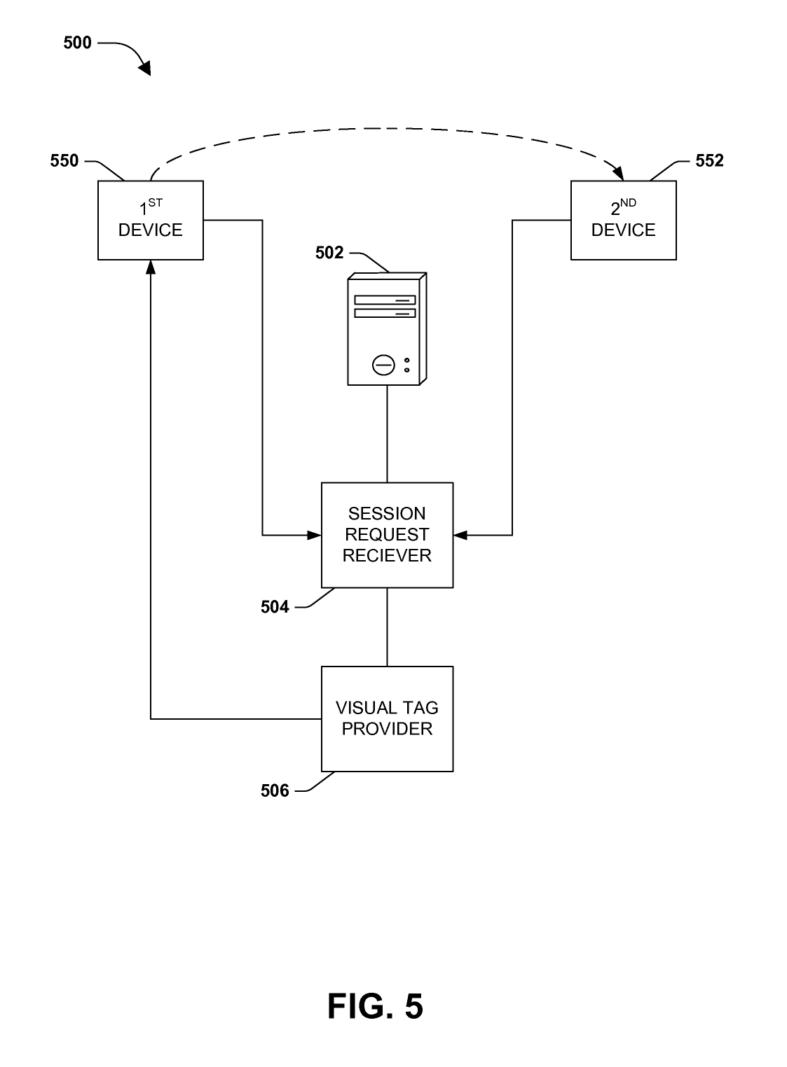

FIG. 5 is a component diagram of an exemplary system 500 for joining two or more devices in a multi-device communication session. A session server 502 is configured to host a multi-device communication session, such as over a network (e.g., intranet, Internet, or a local network). A session request receiving component 504 is operably coupled with the session server 502. The session request receiving component 504 receives a multi-device communication session initiation request from a first device 550, such as a computing device that is operably coupled with, or comprises, a display component. Further, the session request receiving component 504 receives a multi-device communication session joining request from a second device 552.

The multi-device communication session joining request is initiated by (e.g., sent from) the second device 552, and device-session pairing information, comprised in a visual tag displayed by the first device 550, is used for the multi-device communication session joining request. For example, the first device 550 can display a visual tag that comprises the device-session pairing information (e.g., information used to join a session initiated by the multi-device communication session initiation request from a first device). The second device 552 uses the device-session pairing information (e.g., authorization token, session service identification, session expiry information) to request joining the session.

A visual tag providing component 506 is operably coupled with the session request receiving component 504. The visual tag providing component 506 sends the visual tag to the first device 550, where the visual tag comprises the device-session pairing information. For example, the first device 550 can receive the visual tag, display an image of the visual tag on a display coupled with or comprised in the first device 550, and the second device can capture the visual tag for use in the multi-device communication session joining request. In this way, for example the first and second device can be joined in the session hosted by the session server 502, which was initiated by the first device 550.

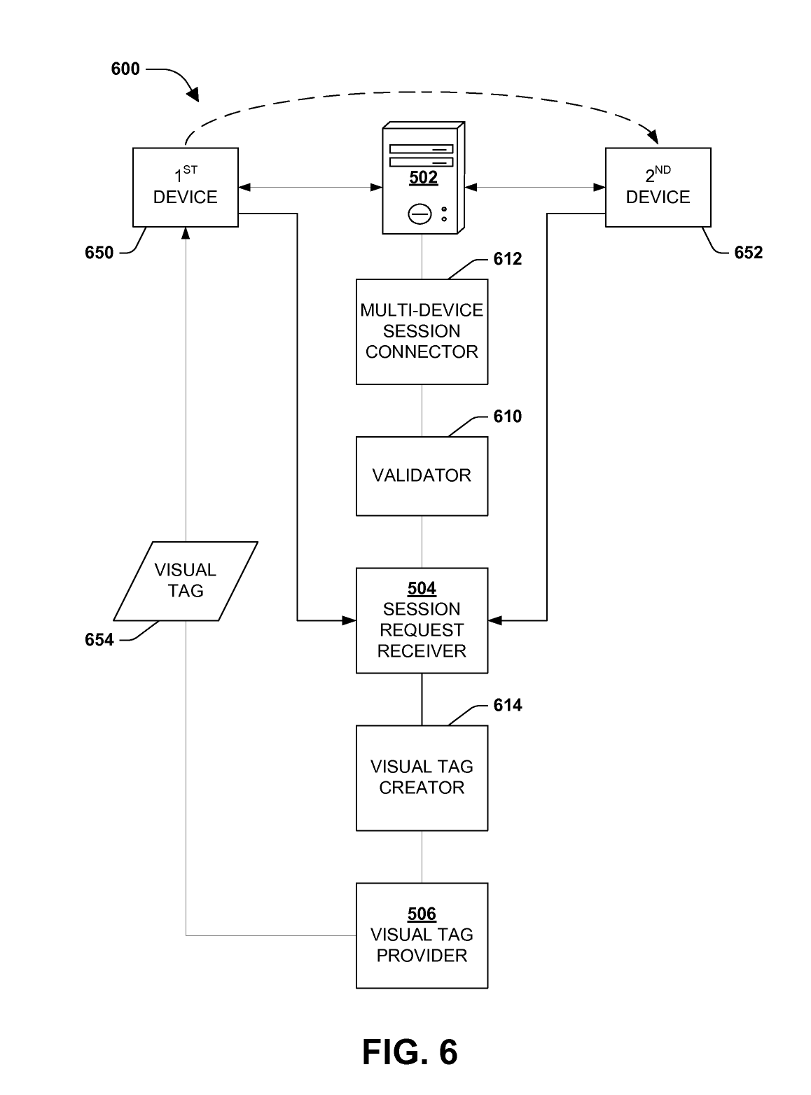

FIG. 6 is a component diagram illustrating an example embodiment 600 of one or more systems described herein. In this example, an extension of FIG. 5 is provided and thus description of elements, components, etc. described with respect to FIG. 5 may not be repeated for simplicity. A validation component 610 can validate the received multi-device communication session joining request from the second device 652 using the device-session pairing information received from the second device 652. A multi-device session connection component 612 can join the second device 652 with the multi-device communication session upon validation of the received multi-device communication session joining request from the second device 652.

For example, the session request receiving component 504 can receive the multi-device communication session joining request from the second device 652, comprising the device-session pairing information from the visual tag 654 displayed by the first device 650. In this example, the validation component 610 can validate the device-session pairing information received by the session request receiving component 504. If validated (e.g., appropriate authorization token and/or expiry information), the multi-device session connection component 612 can connect the second device 652 with the first device 650 in the session hosted by the session server 502.

A visual tag creation component 614 can create the visual tag 654 comprising the device-session pairing information. In one embodiment, the device-session pairing information can comprise information that allows the second device to connect to the multi-device communication session on the session server for a desired duration. For example, the pairing information may comprise an identification for the session server, such as a universal resource identification (URI) (e.g., universal resource locator (URL), such as a web address, or a universal resource name (URN), such as a name of a website or server), that can be used to find the session service on the session server 502.

Further, the pairing information may comprise an authorization token that provides a security measure to inhibit unauthorized devices from joining the session. Additionally, the pairing information may comprise expiry information, such as a session duration and/or start and stop time, or other timing and/or device number related attributes for the session, for example that may enable a host of the session to direct or otherwise exercise some degree of control over the session environment. Once created, for example, the visual tag 654 can be sent to the first device 650 by the visual tag providing component 506.

In one embodiment, the visual tag 654 can comprise a graphical image, such as renderable on the display associated with the first device 650, such that it may be viewed from the perspective of the second device 652 (e.g., line of site, or sent to a remote display viewable by the second device). In one embodiment, the graphical image of the visual tag can be digitally rendered on a display of the first device 650. Further, in this embodiment, the graphic image can be captured by the second device 652 from the display of the first device 650, such as by using a image capture component (e.g., camera) associated with the second device 652. Additionally, the graphical image can be decoded to identify the device-session pairing information, such as using a program resident on the second device 652.

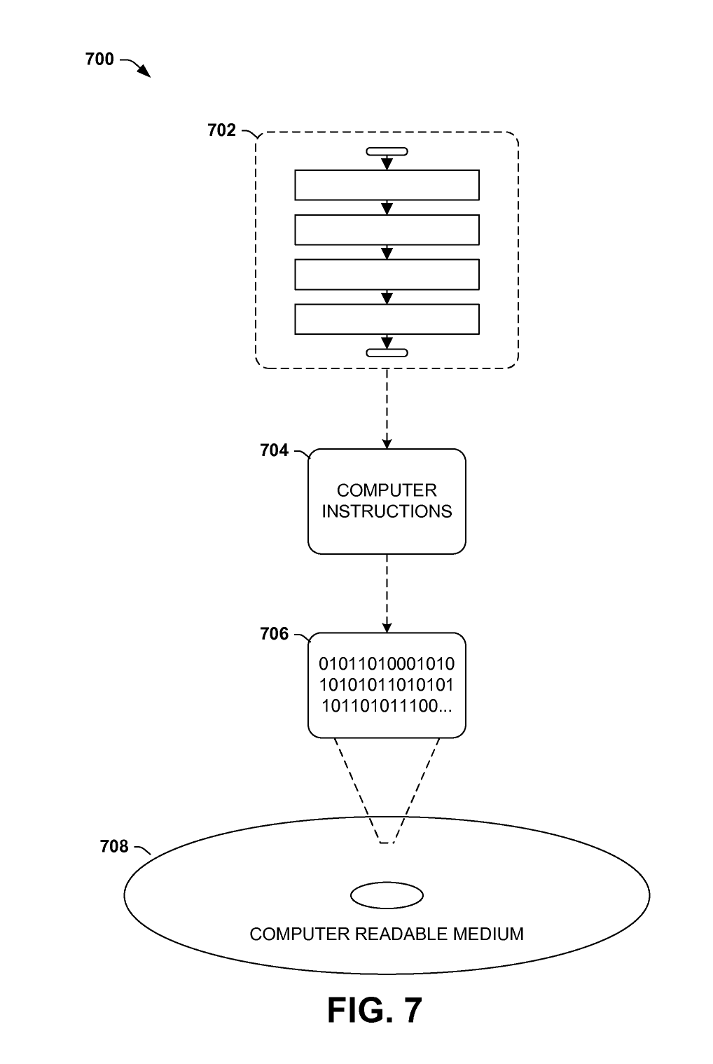

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

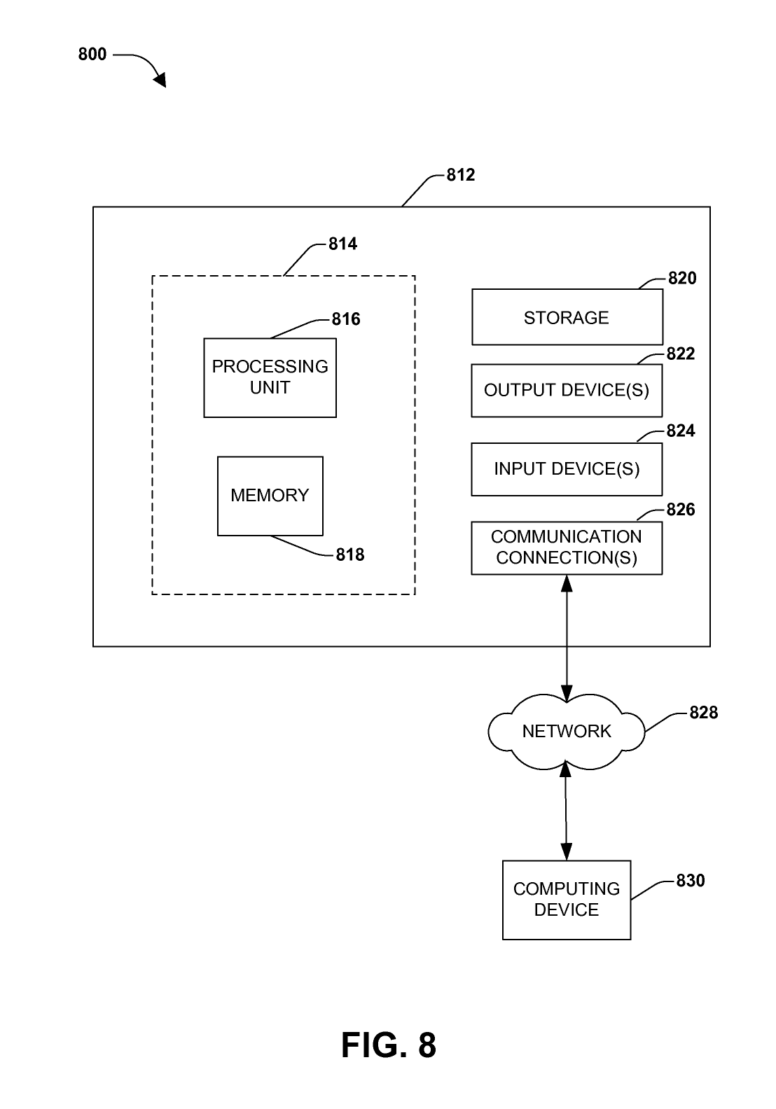

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for joining two or more devices in a multi-device communication session, comprising:
receiving a multi-device communication session initiation request from a first device;
sending a visual tag to the first device, the visual tag comprising device-session pairing information; and
receiving a multi-device communication session joining request from a second device, where the multi-device communication session joining request is initiated by the second device using the device-session pairing information from the visual tag displayed by the first device.

2. The method of claim 1, comprising hosting the multi-device session on a session server.

3. The method of claim 1, comprising generating the visual tag comprising the device-session pairing information in response to the receipt of the request from the first device.

4. The method of claim 1, receiving the multi-device communication session initiation request from a first device comprising receiving a request for registration of the first device in one of:
a new multi-device communication session; and
an existing multi-device communication session.

5. The method of claim 1, comprising rendering the visual tag on a display of the first device viewable by the second device.

6. The method of claim 1, comprising capturing the visual tag displayed by the first device with the second device.

7. The method of claim 6, comprising decoding the captured visual tag to identify the device-session pairing information on the second device.

8. The method of claim 6, comprising determining whether the captured visual tag comprises a valid visual tag on the second device.

9. The method of claim 1, comprising the second device sending the device-session pairing information to a session server in response to capturing the visual tag displayed by the first device.

10. The method of claim 1, comprising verifying the device-session pairing information received from the second device.

11. The method of claim 10, the verifying comprising determining whether the device-session pairing information is valid.

12. The method of claim 10, the verifying comprising determining one or more of:
whether the device-session pairing information comprises a desired time interval for the multi-device communication session;
whether a desired number of devices have already joined the multi-device communication session; and
whether the device-session pairing information comprises valid security information.

13. The method of claim 10, comprising joining the second device to the session if the device-session pairing information is verified.

14. A system for joining two or more devices in a multi-device communication session, comprising:
a session server configured to host a multi-device communication session;
a session request receiving component operably coupled with the session server, and configured to:
receive a multi-device communication session initiation request from a first device; and
receive a multi-device communication session joining request from a second device, where the multi-device communication session joining request is initiated by the second device using device-session pairing information from a visual tag displayed by the first device; and
a visual tag providing component operably coupled with the session request receiving component, and configured to send the visual tag to the first device, where the visual tag comprises the device-session pairing information.

15. The system of claim 14, comprising a validation component configured to validate the received multi-device communication session joining request from the second device using the device-session pairing information received from the second device.

16. The system of claim 14, comprising a multi-device session connection component configured to join the second device with the multi-device communication session upon validation of the received multi-device communication session joining request from the second device.

17. The system of claim 14, comprising a visual tag creation component configured to create the visual tag comprising the device-session pairing information.

18. The system of claim 17, the device-session pairing information comprising information that allows the second device to connect to the multi-device communication session on the session server for a desired duration.

19. The system of claim 14, the visual tag comprising a graphical image that is:
digitally rendered on a display of the first device;
captured by the second device from the display of the first device; and
decoded to identify the device-session pairing information.

20. A method for joining two or more devices in a multi-device communication session, comprising:
receiving a multi-device communication session initiation request from a first device;
generating a visual tag comprising device-session pairing information in response to the receipt of the request from the first device;
sending the visual tag to the first device;
receiving a multi-device communication session joining request from a second device, where the multi-device communication session joining request is initiated by the second device using the device-session pairing information from the visual tag displayed by the first device;
verifying the device-session pairing information received from the second device; and
joining the second device to the session if the device-session pairing information is verified.
